(19) United States
(12) Patent Application Publication
(10) Pub. No.: US 2013/0001414 A1
(43) Pub. Date: Jan. 3, 2013

(54) SYSTEM AND METHOD FOR PRODUCING A MASS ANALYZED ION BEAM FOR HIGH THROUGHPUT OPERATION

(75) Inventors: Victor M. Benveniste, Lyle, WA (US); Frank Sinclair, Quincy, MA (US); Svetlana Radovanov, Marblehead, MA (US); Bon-Woong Koo, Andover, MA (US)

(73) Assignee: VARIAN SEMICONDUCTOR EQUIPMENT ASSOCIATES, INC., Gloucester, MA (US)

(21) Appl. No.: 13/175,404

(22) Filed: Jul. 1, 2011

(51) Int. Cl. H01J 49/10

(52) U.S. Cl. 250/282; 250/281

(57) ABSTRACT

A system for producing a mass analyzed ion beam for implanting into a workpiece, includes an extraction plate having a set of apertures having a longitudinal axis of the aperture. The set of apertures are configured to extract ions from an ion source to form a plurality of beamlets. The system also includes an analyzing magnet region configured to provide a magnetic field to deflect ions in the beamlets in a first direction that is generally perpendicular to the longitudinal axis of the apertures. The system further includes a mass analysis plate having a set of apertures configured to transmit first ion species having a first mass/charge ratio and to block second ion species having a second mass/charge ratio and a workpiece holder configured to move with respect to the mass analysis plate along the first direction.

### FIELD

The present disclosure relates to ion beams. More particularly, the present disclosure relates to producing a mass analyzed ion beam within high throughput ion implantation systems.

### BACKGROUND

For many applications, such as formation of solar cells using ion implantation, the ability to implant at high current in an efficient manner is needed to reduce production costs. Large area sources may have various configurations.

Known beamline implanters may include an ion source, extraction electrodes, a mass analyzer magnet, corrector magnets, and deceleration stages, among other components. The beamline architecture provides a mass analyzed beam such that ions of a desired species are conducted to the substrate (workpiece). However, one disadvantage of the beamline implanter architecture is that the implantation current and therefore the throughput may be insufficient for economical production in applications such as implantation of solar cells. For example, current beamline implanters are not ideally suited to continuous feed of workpieces for ion implantation.

Plasma doping tools (PLAD) may provide a more compact design that is capable of producing higher beam currents at a workpiece. In a PLAD tool, a workpiece may be immersed in a plasma and provided with a bias with respect to the workpiece to define the ion implantation energy. However, PLAD system designs suffer from the fact that a mass analysis capability does not exist, thereby preventing the screening of ions of undesirable mass from impinging on the workpiece. For example, mass analysis may entail production of large magnetic fields necessary to deflect unwanted ions. In addition, magnetic analyzers required to produce such fields may be difficult to scale up in size to dimensions suitable for large throughput.

It will therefore be apparent that a need exist to improve ion implanter architecture, especially in the case of high throughput large ion beams.

### SUMMARY

Embodiments of the present disclosure are directed to implanters that include a large area ion extraction system and a single-magnet configuration that produce a mass resolution for ion beams incident on a workpiece. In accordance with one embodiment, a system for producing a mass analyzed ion beam for implanting into a workpiece comprises an extraction plate comprising a set of apertures each having a longitudinal axis, the set of apertures configured to extract ions from an ion source to form a plurality of beamlets. The system also includes an analyzing magnet region configured to provide a magnetic field to deflect ions in the beamlets in a first direction that is generally perpendicular to the longitudinal axis of the aperture. The system further includes a mass analysis plate having a set of apertures configured to transmit first ion species having a first mass/charge ratio and to block second ion species having a second mass/charge ratio, and a workpiece holder configured to move with respect to the mass analysis plate along the first direction.

In another embodiment a method of providing a mass analyzed ion beam for implanting a workpiece comprises forming unanalyzed beamlets having a ribbon beam shape whose cross-section is defined by a longitudinal direction. The method further comprises deflecting a first and second group of ions in the unanalyzed beamlets over respective first and second deflection distances in a first direction generally perpendicular to the longitudinal direction. The method also comprises blocking the second group of ions with an analysis plate and translating the workpiece with respect to the analysis plate along the first direction, wherein ions transmitted through the analysis plate produce a uniform ion implantation profile at the workpiece along the longitudinal direction and along the first direction.

### BRIEF DESCRIPTION OF THE DRAWINGS

For a better understanding of the present disclosure, reference is made to the accompanying drawings, which are incorporated herein by reference and in which:

FIGS. 1 and 2 present a top cross-sectional and side plan view, respectively, of features of an exemplary implantation system;

FIG. 3 presents an exemplary side plan view of an ion beam configuration;

FIG. 4a presents another exemplary side plan view of an ion beam configuration;

FIG. 4b presents current density curves from the ion beam configuration of FIG. 4a;

FIG. 5 is a graph that depicts calculated ion trajectories in a magnetic field for various ion species;

FIG. 6 presents a top cross-sectional view of an exemplary configuration of extraction and mass analysis plates;

FIG. 7 depicts a top cross-sectional view of an alternative exemplary ion implantation system;

FIG. 8a depicts a top cross-sectional view of another alternative exemplary ion implantation system; and

FIG. 8b depicts a perspective view of the ion implantation system generally illustrated at FIG. 8a.

### DETAILED DESCRIPTION

The present invention will now be described more fully hereinafter with reference to the accompanying drawings, in which embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

In the description and figures to follow a set of Cartesian coordinate system is consistently used to define and describe the operation of embodiments.

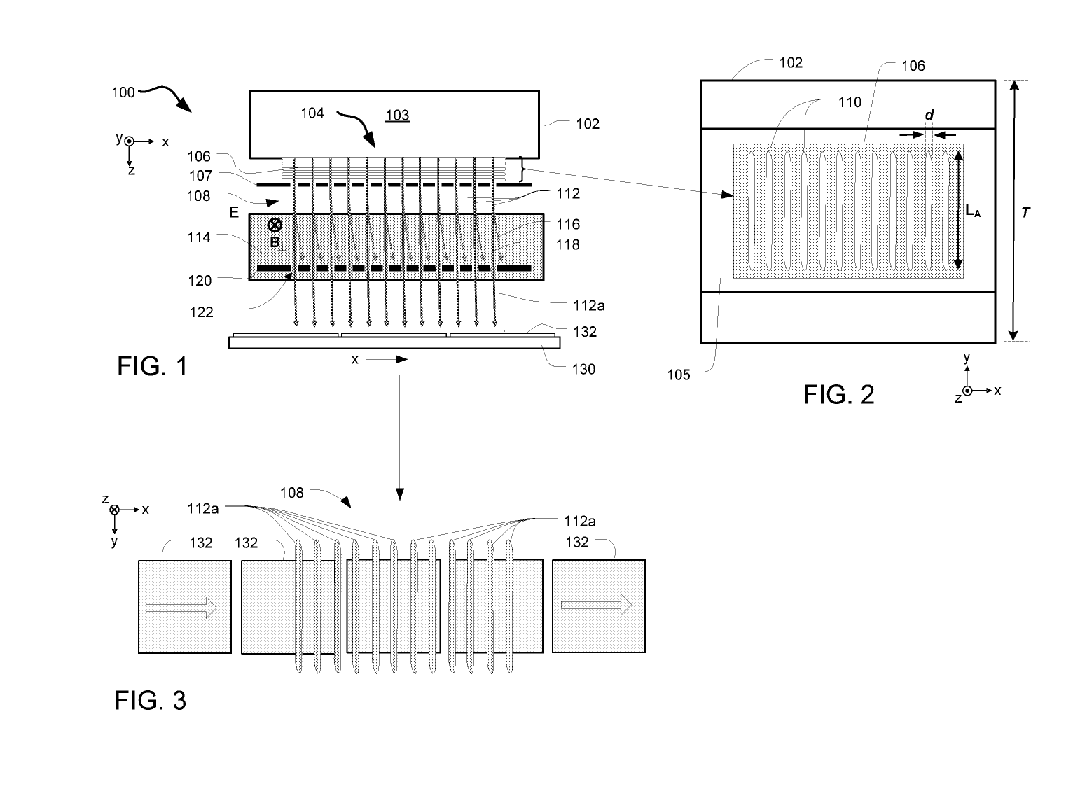

FIG. 1 is a schematic plan view of an exemplary ion implantation system 100. This ion implantation system employs a large area ion source 102, which may be one of many designs as known in the art. An extraction plate system 104 may be disposed along one side of the ion source adjacent beam block 107. The extraction plate system 104 may have one or more extraction plates 106 arranged in serial fashion to extract an ion beam 108 from ion source 102. Each extraction plate 106 may be provided with a plurality of elongated slots 110 (or “apertures”) that have a high aspect ratio. Referring also to FIG. 2, which depicts a side plan view of ion source 102 and extraction plate 106, in some embodiments, the aperture length dimension L_{A} may be about two or more times greater than the aperture width d, as depicted in FIG. 2. The apertures 110 may be arranged with their long axes parallel to each other as also depicted in FIG. 2. The apertures 110 may also be mutually arranged in side-by-side fashion, for example, as shown in FIG. 2. Accordingly, the apertures 110 may produce a plurality of beamlets 112 that are transmitted through the extraction plate system 104 and pass through an analyzing magnet region 114.

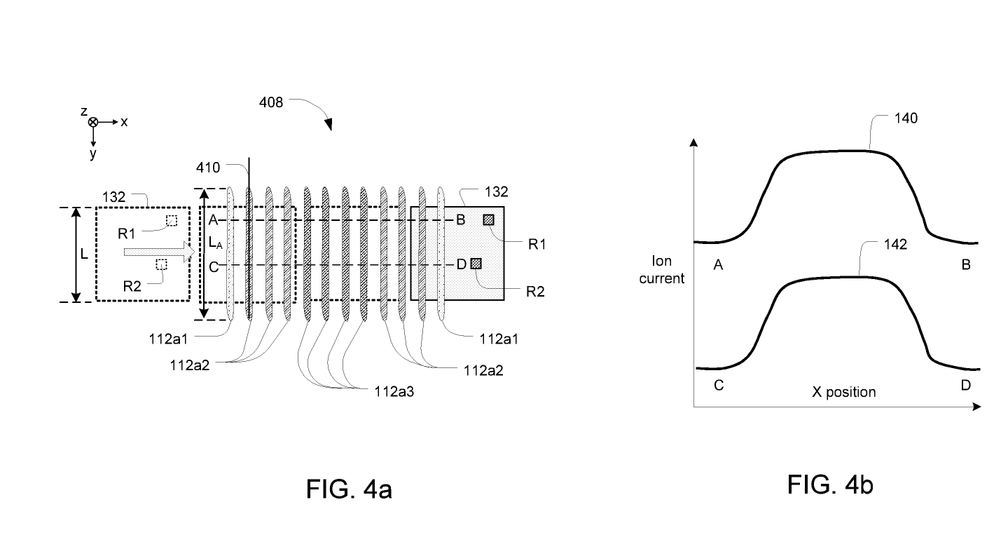

In various embodiments, the analyzing magnet region 114 may include permanent magnets or an electromagnet, where the analyzing magnetic region is configured to produce a moderate dipole magnetic field that produces an orthogonal force on a passing charged particle. When beamlets 112 pass through the analyzing magnet region 114, ions within the beamlets may experience a deflecting force that acts to deflect lighter ions 116 and heavier ions 118 in a direction that is orthogonal to the direction of propagation of the beamlets 112 (that is, orthogonal to the z direction) and is orthogonal to the long axes of the beamlets 112 (see element 410 if FIG. 4a), which are parallel to the y-direction.

In particular, lighter ions 116 may be deflected in the x-direction a greater lateral distance from their initial trajectories than the deflection imparted to heavier ions 118, which may travel in a substantially straighter trajectory as shown. As used herein, the terms “lighter ions” and “heavier ions” generally refer to ions having relatively smaller mass/charge ratios and those ions having relatively larger mass/charge ratios, respectively.

Ion implantation system 100 also includes a screening plate 120 (hereinafter also termed “mass analysis plate”) that includes apertures 122, which may be configured to pass heavier ions 118. Apertures 122 may also be configured to block lighter ions 116, whose trajectories are more curved, resulting in a displacement that causes their trajectories to intercept the mass analysis plate 120. Accordingly, mass analysis plate 120 may produce a series of mass analyzed beamlets 112a that are mass analyzed beamlets, wherein the mass analyzed beamlets 112a have a larger fraction of the straighter-trajectory ions (which may be heavier ions). In some embodiments the size, shape and arrangement of apertures in mass analysis plate 120 may be configured similarly to that in extraction plate 106.

As viewed in FIG. 1, the workpiece (substrate) holder 130 may be arranged under mass analysis plate 120 to intercept those ions that are extracted from ion source 102 and conducted in selected trajectories to workpieces 132. In one example, in operation, a plasma (not shown) within ion source 102 may be biased with respect to the workpiece holder 130 in accordance with a desired ion implantation energy. In some embodiments, the workpiece holder 130 may also be configured to scan workpieces 132 in the x-direction with respect to ion source 102. In other embodiments the workpiece holder 130 may be configured to transport workpieces 132 in a continuous flow for maximum throughput, as depicted in FIG. 3. For example, the workpiece holder may be a continuous belt or other continuous drive. In particular, FIG. 3 presents a top plan view of mass analyzed beamlets 112a as the beamlets intercept workpieces 132, which may flow in a continuous series of workpieces along the x-direction, as depicted. For clarity, the ion source 102, extraction plate system 104, analyzing magnet region 114 and mass analysis plate 120 are removed in FIG. 3. As described in detail below, a uniform implantation profile may be achieved along the x-direction using the configuration of FIG. 3.

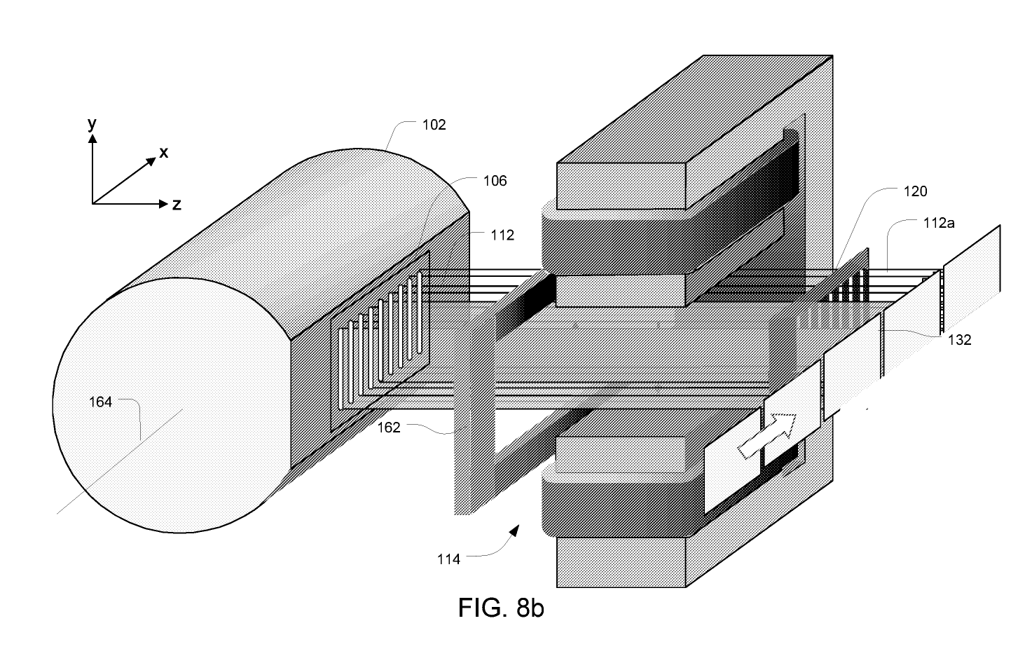

Referring again to FIG. 2, in various embodiments, the dimensions of ion source 102 are configured to provide an ion current that is uniform along the entire aperture length L_{A} of apertures 110. This may be accomplished by providing a chamber for ion source 102 that has a greater dimension T than the aperture length L_{A} in the y-direction, as depicted. In some embodiments, the chamber (not separately depicted) for ion source 102 may be shaped as a truncated cylinder, as also illustrated in FIG. 8b. The extraction plate 106 may be arranged adjacent a flat 105 of the truncated cylinder in a manner that the long axes of apertures 110 are perpendicular to the cylinder axis 164.

Advantageously, in accordance with embodiments where ion current is uniform along L_{A}, workpieces may be fabricated with a uniform implantation profile in both the x- and y-directions by scanning or providing a continuous flow of the workpieces along the x-direction while intercepting ion beam 108. A uniform implantation profile in both x- and y-directions may be obtained even when the ion current along the x-direction is not uniform, as illustrated in FIG. 4a. The exemplary ion beam 408 of FIG. 4a comprises multiple mass analyzed ribbon beamlets 112a in which the ion density is uniform along the y-direction, that is, parallel to the long axes 410 of the beamlets. In particular, the ion density may be uniform over the entire length L_{A}. However, the ion density may vary between different beamlets. For example, the mass analyzed beamlets 112a1, which are disposed at first and last positions of the beamlets, may have a first ion density, which may be relatively low. The mass analyzed beamlets 112a2, which are disposed at intermediate positions, may have a second ion density, which may be higher than the first ion density. Interior mass analyzed beamlets 112a3, which are located in a central portion of ion beam 408, have a third ion density, which may be relatively higher than the first and second ion density. Such a non-uniform beam pattern (along the x-direction) may be produced for example, when an ion source 102 has a relatively higher ion density towards central portions 103 of the ion source. Nevertheless, because the mass analyzed beamlets 112a are uniform along the y-direction (the direction parallel to the long axes 410), each workpiece 132 may receive a uniform ion dose as it passes under the ion beam 108.

This may be more clearly illustrated by considering two arbitrarily selected regions R1 and R2 of workpiece 132. When workpiece 132 scans or flows continuously under ion beam 408, region R1 scans through the ion beam 408 along the path A-B and region R2 scans through the ion beam 408 along the path C-D. The total ion dose received by regions R1 and R2 as workpiece 132 scans in the x-direction may be represented by the area under respective curves 140 and 142 shown in FIG. 4b. Neglecting positions between mass analyzed beamlets 112a, the curves may represent the ion density as a function of x position when respective regions R1 and R2 scan or continuous flow along paths A-B and C-D, respectively. Because the ion density is uniform along the y-direction, at each position along the x-direction, the ion density is the same in curves 140 and 142. Accordingly, curves 140 and 142 may be equivalent, which indicates that same total ion dose is provided to regions R1 and R2 as workpiece 132 scans through ion beam 408. The same goes for any other points that may be chosen on workpiece 132, since all of the regions of workpiece 132 scan under the same series of mass analyzed beamlets 112a and should thereby experience the same ion dose curve equivalent to curves 140 or 142.

In some embodiments of ion implantation system 100, one or more current monitors (not shown) may be provided, which may facilitate maintaining ion dose uniformity over time, and may aid in adjusting ion dose to be implanted into a workpiece. For example, a current monitor may be provided to monitor current for each mass analyzed beamlet 112a. At any given time, the implantation system 100 may calculate the total actual ion dose implanted into a workpiece based on the sum of the measured ion currents at each beamlet and based upon the speed of scanning of a workpiece with respect to the ion beam 108. Depending on the calculated total ion dose and the target ion dose to be implanted into a substrate, the scan speed (or flow speed) may be adjusted as needed.

The arrangement depicted in FIGS. 1-4 advantageously enables a uniform high throughput mass analyzed ion implantation process for workpieces whose size L perpendicular to the scan (or continuous flow) direction is less than or equal to the aperture length L_{A}. For example, in ion implantation system embodiments for processing 156×156 mm solar cells, the aperture length L_{A} used to create mass analyzed beamlets 112a may be about 175 mm to about 200 mm or so. This aperture length is sufficient to uniformly implant such solar cells so long as the solar cells are fed through the mass analyzed beamlets 112a in a 1×N fashion.

Referring again to FIGS. 2 and 8b, a further advantage of providing a relatively modest aperture length L_{A} is that mass analysis of ribbon beams may be performed using a relatively compact analyzing magnet region 114. In other words, a magnet used to deflect ions in beamlets 112 need only produce a deflecting field over a length in the y-direction that is comparable to L_{A} (such as about 200 mm) while the beamlets 112 pass through the analyzing magnet region 114. This obviates the need to scale an analyzing magnet in the y-direction, which may be difficult, beyond the dimension (in the y-direction) of a single workpiece.

A further advantage of embodiments of this disclosure is that the dimension of ion source 102/extraction plate system 104 may be scaled up along the x-direction to much larger dimensions without the need to ensure current uniformity along the x-direction. This is because, as illustrated above with regard to FIGS. 4a, 4b, the workpieces may receive uniform implantation profiles even when ion density varies between mass analyzed beamlets 112a. Thus, an ion source configuration having any convenient length along the x-direction may be employed to produce uniformly implanted workpieces. By scaling up in the x-direction, the scanning speed of continuously fed workpieces may be increased. For example, referring again to FIG. 3, a 1×N flow of workpieces is illustrated. By increasing the length of ion beam 108 along the x-direction by a factor of two while maintaining current density in the mass analyzed beamlets 112a, the scan speed of workpieces 132 may be increased by the same factor to implant the same dose into workpieces 132. Moreover, it will be readily appreciated by those of skill in the art that scaling of analyzing magnetic region 114 along the x-direction does not present as difficult challenges as scaling in the y-direction. Thus, in some embodiments, the x-dimension of an ion source 102 and associated extraction plate(s) 106 may be one meter or more.

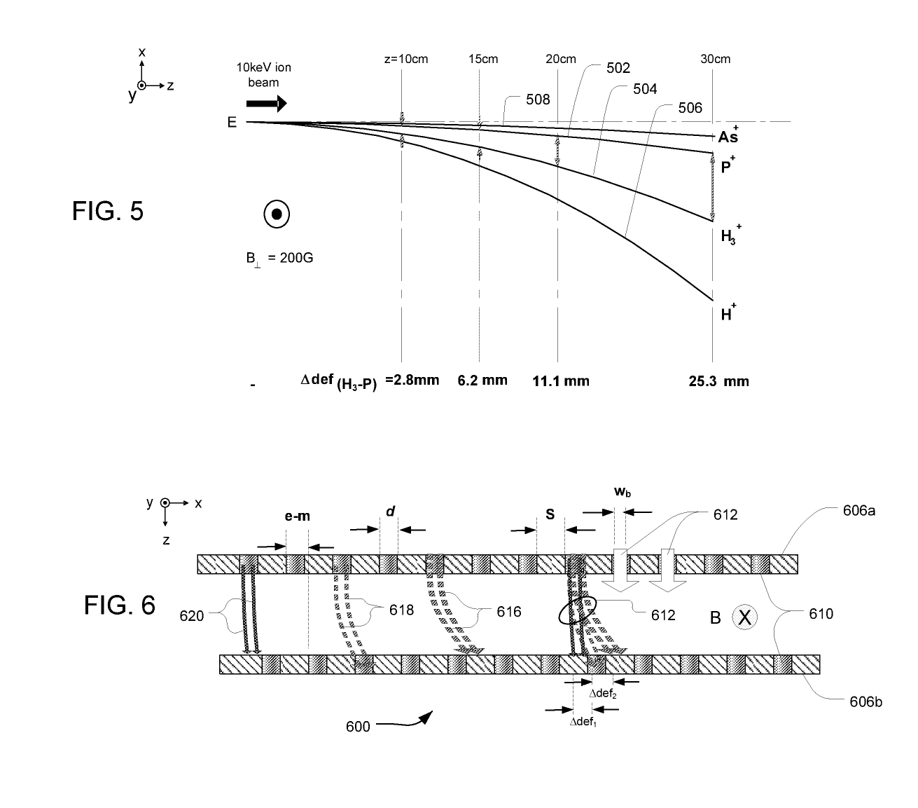

Consistent with various embodiments of the disclosure, a compact beamline design is also provided in the z-direction. Referring again to FIGS. 1 and 2, the small aperture width d in extraction plate 106 produces beamlets 112 that are narrow in the x-direction. In particular, the aperture width and beamlet width may be about one centimeter and more typically about 5 mm, or less. By providing narrow beamlets 112, only a relatively small deflection of ions in the x-direction may be sufficient to separate lighter ions 116 from heavier ions 118 when the ions impinge on mass analysis plate 120. The relatively small required deflection, in turn, requires only a modest travel distance in the z-direction and modest magnetic field to separate commonly used ions at ion energies typically used for implantation of workpieces, as detailed below with respect to FIGS. 5 and 6. Consequently, the separation between ion source and workpiece in the z-direction may be minimized.

Some embodiments may specifically provide a mass analyzed beam for implanting dopant species into a workpiece, such as a solar cell or an integrated circuit substrate. In some embodiments, the ion implantation system 100 operates to screen lighter ions such as Hₓ⁺ (x=1, 2, 3) and transmit heavier ions, such as the aforementioned phosphorous ions. In other embodiments, the ion implantation system 100 operates to transmit lighter ions and block heavier ions, while in further embodiments; the ion implantation system 100 operates to screen selected ions from both heavier ions and lighter ions.

The ion species may be derived from a plasma source that may contain, in addition to the dopant species, unwanted ion species, such as hydrogen ions (Hₓ⁺). FIG. 5 presents the results of calculations of trajectories of 10 keV ions subject to a moderate magnetic field of 200 Gauss strength that is arranged orthogonal to the initial beam trajectory. Referring also to FIG. 1, point E may represent the point at which ions from beamlets 112 initially enter analyzing magnetic region 114, at which point their direction of propagation (principal beam axis) is parallel to the z-direction. The example of FIG. 5 shows the trajectory of some typical ion species that may be present in a plasma used to provide phosphorous doping to a workpiece. As is evident, H⁺ ions 506 and H₃⁺ ions 504 are deflected to a much larger extent than are P⁺ ions 502. For example, a differential deflection Δdef, which represents the difference in the lateral deflection along the x-direction between H₃⁺ ions and P⁺ ions, is about 11.1 mm at a point along the z-direction that is 20 cm from E. On the other hand, As ions 508 are deflected less than P⁺ ions 502.

Consistent with embodiments of the disclosure, the results of FIG. 5 may be used to optimize experimental parameters of a compact mass analyzed ion implantation system. For example, the data indicate that an implantation system having a 200 Gauss analyzing magnetic region whose length in the z-direction is 20 cm may produce a Δdef value between H₃⁺ ions and P⁺ ions of about 11.1 mm. In order to separate H₃⁺ ions from P⁺ ions based on the Δdef value embodiments of the disclosure may take advantage of the ribbon beamlet structure of ion beam 108. Because the ion beam 108 is divided into individual beamlets 112, unwanted Hₓ⁺ ions (x=1,2,3) within each beamlet 112 may be effectively screened by deflecting the ions along the x-direction only a distance comparable to the width d of the apertures used to form the beamlets 112. The unwanted ions may be collected on the mass analysis plate 120 while the desired phosphorous ions pass through apertures of the mass analysis plate 120. Details of mass analysis of ribbon beamlets consistent with present embodiments are more extensively illustrated with reference to FIG. 6.

FIG. 6 presents a cross-sectional view of exemplary mass analysis system 600 including an extraction plate 606a and a mass analysis plate 606b. As illustrated, and in some embodiments, the plates may include a similar configuration of apertures and have similar overall dimensions in the x- and y-directions.

In operation, extraction plate 606a of mass analysis system 600 may extract ions as unanalyzed beamlets 612 that pass through apertures 610 substantially parallel to the direction z, as illustrated. In one example, an extraction potential may be applied to extraction plate 606a that defines unanalyzed beamlets 612, whose width w_{b} may be less than the width d of apertures 610. The unanalyzed beamlets 612 may include multiple different ion species of varying mass/charge ratio. As illustrated in FIG. 6, the unanalyzed beamlets 612 contain light ions 616, intermediate ions 618, which have a mass/charge ratio greater than that of light ions 616, and heavy ions 620, which have a mass/charge ratio greater than that of intermediate ions 618. For clarity, the trajectories of ions 616, 618 and 620 are also depicted separately, although it will be appreciated that each aperture of extraction plate 606a may transmit ions 616, 618, and 620, which constitute the unanalyzed beamlet 612.

As illustrated in FIG. 6, a magnetic field B disposed between extraction plate 606a and mass analysis plate 606b creates field lines perpendicular to the trajectories of unanalyzed beamlets 612, which creates a force to deflect ions in the x-direction as the ions traverse between extraction plate 606a and mass analysis plate 606b. In one example light ions 616 may represent Hₓ⁺ (x=1, 2, 3) ions, intermediate ions 618 may represent P⁺ ions, and heavy ions 620 may represent As ions. The trajectories of heavy ions 620 are slightly deflected from their initial direction at extraction plate 606a, while the trajectories of intermediate ions 618 and light ions 616 are more strongly deflected in the x-direction.

By appropriate design of aperture width d, aperture spacing S, and offset (designated as “e-m” in FIG. 6) between extraction plate 606a and mass analysis plate 606b, the unanalyzed beamlets 612 may be analyzed to transmit only select ions. In the mass analysis system 600, the offset e-m is such that heavy ions 620 are blocked by mass analysis plate 606b, while intermediate ions 618 are transmitted through apertures 610 of mass analysis plate 606b. Light ions 616, which are deflected more than intermediate ions 618, are also blocked by mass analysis plate 606b. In this manner, mass analysis system 600 transmits mass analyzed beamlets which contain intermediate ions 618, but do not contain light ions 616 or heavy ions 620.

In order to aid proper design of a mass analysis system, the different components of ion beams may be characterized by one or more Δdef values, similar to that described above with respect to FIG. 5. FIG. 6 provides two examples of differential deflection Δdef₁ and Δdef₂, which characterize the deflection difference between heavy ions 620 and intermediate ions 618, and that between intermediate ions 618 and light ions 616, respectively. As shown in FIG. 5, the value of Δdef may be varied by varying the distance through which the ions travel through an orthogonal magnetic field along the z-direction, as well as the difference between the masses (or mass/charge ratios) of the ions in question. It will also be apparent to those of ordinary skill that Δdef additionally depends upon the ion energy and strength of magnetic analyzing field.

In further embodiments, the spacing S between apertures may be greater than or equal to the aperture width d, to help ensure that the beamlet width w_{b} of deflected light ions 616 is not greater than the spacing between apertures, which might permit at least some deflected light ions 616 to pass through at least one of a pair of adjacent apertures. As noted previously, the aperture width d may be about one centimeter or less (typically −5 mm) in various embodiments. Thus, a differential deflection Δdef on the order of one centimeter or less may be sufficient to provide effective mass analysis of ions beams configured as narrow ribbon beamlets according to the present embodiments.

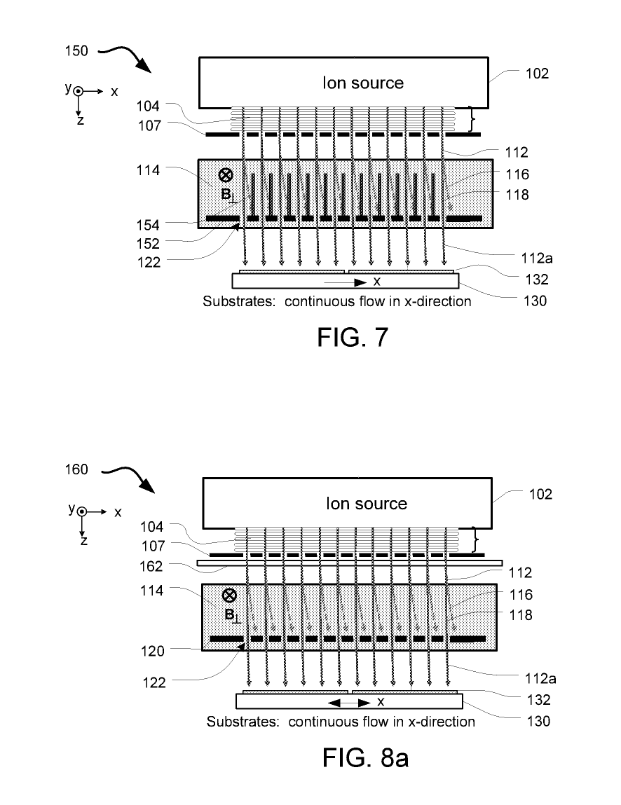

In order to provide improved mass analysis, other ion implantation system embodiments employ a mass analysis plate coupled to baffles configured to intercept unwanted ions. FIG. 7 depicts an implantation system 150 that includes a mass analysis plate 152 and baffles 154 that extend from the surface of mass analysis plate 152 toward extraction plate system 104. In some embodiments, the baffles 154 may extend in a direction generally parallel to the z-direction so that the baffles do not intercept heavier ions 118, which may have trajectories that are close to parallel to the z-direction. In this manner, the baffles 154 may intercept lighter ions 116, which undergo a more pronounced deflection in the x-direction, while transmitting the heavier ions 118. In some embodiments, the baffles 154 may form an integral part of the mass analysis plate 152, while in still other embodiments, the baffles 154 need not be in contact with mass analysis plate 152.

In further embodiments of an ion implantation system, a magnetic isolation may be provided to shield the ions source from the influence of the analyzing magnet region. FIGS. 8a and 8b depict an ion implantation system 160 that includes a magnetic “clamp” 162 that isolates ion source 102 from analyzing magnet region 114. Although depicted as a gasket shape, in some embodiments, the magnetic clamp 162 may be a steel housing that encloses ion source 102. FIG. 8b depicts a perspective view of an embodiment of the ion implantation system 160 with the beam block 107 and mass analysis plate 120 omitted for clarity. As illustrated in the perspective view of FIG. 8b, the analyzing magnet region 114 may be a C-shaped magnet assembly. The magnetic clamp 162 is positioned to prevent any magnetic field generated in analyzing magnet region 114 from extending to ion source 102.

In summary, the inventive ion implantation systems of the present disclosure provide multiple advantages over known systems. To begin with, the partitioning of an ion beam into multiple parallel ribbon beamlets facilitates producing a high ion current mass analyzed ion beam in a compact geometry, since only small deflection distances are required for mass analysis. The small deflection distances, in turn, facilitate a more compact spacing of ion source and workpiece, consistent with a high current density. Moreover, the extraction plate architecture that provides an analyzed beam is scalable in an x-direction to larger beam dimensions without the need to scale features such as magnetic field strength. In other words, the local deflection distance required to provide a mass analyzed beam is independent of the overall beam dimensions. Exemplary ion implantation systems of the present disclosure may be used, for example, where high throughput, high current implantation is required using a single ion species and where only a single ion energy is employed. Embodiments of ion implantation systems that employ multiple ion energies with a smaller energy range are also possible. Additionally, by providing scanning (and/or continuous flow) of workpieces in a direction orthogonal to the long axes of a series of ribbon beamlets, uniform ion implantation of the workpieces may be accomplished without the need to establish ion current uniformity in the scan direction. Furthermore, increasing throughput does not require scaling of magnetic analyzers in a y-direction since scaling to increase throughput need only be performed in the x-direction.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings.

Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system for producing a mass analyzed ion beam for implanting into a workpiece, comprising:
an extraction plate comprising a set of apertures each having a longitudinal axis, the set of apertures configured to extract ions from an ion source to form a plurality of beamlets;
an analyzing magnet region configured to provide a magnetic field to deflect ions in the beamlets in a first direction that is generally perpendicular to the longitudinal axis of the apertures and to a direction of propagation of the beamlets;
a mass analysis plate having a set of apertures configured to transmit first ion species having a first mass/charge ratio and to block second ion species having a second mass/charge ratio; and
a workpiece holder configured to move with respect to the mass analysis plate along the first direction.

2. The system of claim 1, wherein the set of apertures in the mass analysis plate defines a pattern substantially similar to that defined by the set of apertures in the extraction plate.

3. The system of claim 1, wherein the first ion species has a first mass/charge ratio that is greater than a second mass/charge ratio of the second ion species, the extraction plate and the mass analysis plate being mutually configured wherein the mass analysis plate blocks a greater fraction of the second ion species than the first ion species.

4. The system of claim 1, wherein the ion source comprises a steel enclosure configured to shield the ion source from the analyzing magnet region.

5. The system of claim 1, further comprising a set of baffles disposed between the extraction plate and mass analysis plate and arranged to intercept the second ion species.

6. The system of claim 1 wherein the set of apertures are defined by an aperture length L_{A} parallel to the longitudinal axis, wherein L_{A} is greater than a dimension of the workpiece parallel to the longitudinal axis.

7. The system of claim 2, wherein apertures of the mass extraction plate are interoperable with apertures of the mass analysis plate to produce mass-analyzed beamlets having a ribbon beam shape, wherein each of the mass-analyzed beamlets provides a uniform ion current in a second direction parallel to the longitudinal axis of the apertures of the extraction plate.

8. The system of claim 7, further comprising one or more current detectors, each current detector configured to measure current in one of the mass-analyzed beamlets.

9. A method of providing a mass analyzed ion beam for implanting a workpiece, comprising:
forming, using an extraction plate, unanalyzed beamlets having a ribbon beam shape whose cross-section is defined by a longitudinal direction;
deflecting a first and second group of ions in the unanalyzed beamlets over respective first and second deflection distances in a first direction generally perpendicular to the longitudinal direction;
blocking the second group of ions with an analysis plate; and
translating the workpiece with respect to the analysis plate along the first direction, wherein ions transmitted through the analysis plate produce a uniform ion implantation profile at the workpiece along the longitudinal direction and along the first direction.

10. The method of claim 9, comprising providing the analysis plate with a configuration of apertures substantially similar to that in the extraction plate.

11. The method of claim 9, comprising providing a ribbon beam whose dimension along the longitudinal direction is larger than a dimension of the workpiece along the longitudinal direction.

12. The method of claim 9, further comprising providing a set of electrode plates arranged in series with the extraction plate, the set of electrode plates each having an aperture configuration similar to that of the extraction plate, wherein the set of electrode plates and extraction plate comprise an extraction assembly.

13. The method of claim 9, wherein the first group of ions has a greater mass/charge ratio than the second group of ions, the method further comprising configuring the extraction plate and the analysis plate so that the analysis plate blocks a greater fraction of the second group of ions than the first group of ions.

14. The method of claim 9, further comprising magnetically shielding the ion source from a magnetic analyzer used to deflect the first and second group of ions.

15. The method of claim 9, further comprising providing baffles between the extraction plate and analysis plate to intercept the second group of ions.

16. The method of claim 9, wherein the ions transmitted through the analysis plate form one or more analyzed beamlets, the method further comprising providing one or more current detectors to measure current in respective one or more analyzed beamlets.

17. The method of claim 16, further comprising adjusting a scan speed of the workpiece based upon current detected at the one or more current detectors.

18. An ion implantation system, comprising:
an ion source that produces a first ion species having a first mass/charge ratio and a second ion species having a second mass/charge ratio;
an extraction plate having a set of apertures defined by a longitudinal axis of the apertures and configured to extract ions from the ion source to form a plurality of beamlets;
an analyzing magnet region configured to provide a magnetic field to deflect ions in the beamlets in a first direction that is generally perpendicular to the longitudinal axis of the apertures and to a direction of propagation of the beamlets;
a mass analysis plate having a set of apertures, the mass analysis plate mutually configured with the extraction plate to transmit the first ion species having the first mass/charge ratio and block the second ion species having the second mass/charge ratio; and
a workpiece holder configured to move with respect to the mass analysis plate along the first direction, wherein ion current at the workpiece holder along a second direction parallel to the longitudinal axis of the apertures is substantially uniform over a length L_{A} of the apertures.

19. The system of claim 18, further comprising a steel housing to magnetically isolate the ion source from the analyzing magnet region.

20. The system of claim 18, further comprising baffles disposed between the extraction plate and mass analysis plate and arranged to intercept the second ion species.
